(19) United States
(12) Patent Application Publication
(10) Pub. No.: US 2003/0182003 A1
(43) Pub. Date: Sep. 25, 2003

(54) Playback apparatus, headphone, and playback method

(76) Inventor: Kazuhiro Takashima, Tokyo (JP)

Correspondence Address: PILLSBURY WINTHROP, LLP, P.O. BOX 10500, MCLEAN, VA, 22102, US

(21) Appl. No.: 10/393,365

(22) Filed: Mar. 21, 2003

(30) Foreign Application Priority Data
Mar. 22, 2002 (JP) 2002-081796

(51) Int. Cl. G06F 17/00; G06F 15/16; H04R 5/02

(52) U.S. Cl. 700/94; 381/309; 709/217

(57) ABSTRACT

In a playback apparatus formed by a playback apparatus main body and wireless headphone, music data is read out from a recording medium, is decoded by a decoder, and the decoded music data is transmitted from a digital wireless transmitter to the headphone in the form of digital data in the playback apparatus main body. In the wireless headphone, the music data transmitted from the playback apparatus main body is received by a digital wireless receiver, the received music data is temporarily saved in a buffer memory, the saved music data is read out from the buffer memory, the readout data is converted by a D/A converter from digital data into an analog signal, and the analog signal is converted into sound via loudspeakers.

### CROSS-REFERENCE TO RELATED APPLICATIONS

This application is based upon and claims the benefit of priority from the prior Japanese Patent Application No. 2002-081796, filed Mar. 22, 2002, the entire contents of which are incorporated herein by reference.

### BACKGROUND OF THE INVENTION

1. Field of the Invention

The present invention relates to a playback apparatus, headphone, and playback method for playing back music.

2. Description of the Related Art

In recent years, music players which allow users to enjoy listening to music in a hands-free state are commercially available. There are various types of music players, and for example, a portable music player which has a music player main body and a wireless headphone is known. In a music player of this type, the user enjoys listening to played music while putting the music player main body in his or her pocket or bag, and wearing the wireless headphone on his or her head.

On the side of the music player main body, music data is read out from a recording medium, and executes a process for decoding the readout music data (including a process for decompressing compressed data). In general, the read process is intermittently done under the control of a controller (processor or the like), and causes a delay time in the decoding process. Such delay time in the read and decoding processes results in discontinuity of music upon playback.

To solve this problem, the music player main body normally includes a buffer memory for temporarily storing music data. With the buffer memory, the delay time of the data processes can be absorbed, and music data can be transferred from the buffer memory to a D/A (digital/analog) converter while maintaining the data transfer rate required to play back data. The music data is converted by the D/A converter into an analog signal, which is sent to the wireless headphone via a wireless communication.

On the other hand, the wireless headphone receives the analog music data sent from the music player main body via a wireless communication, and converts and outputs, via loudspeakers, that data as sound that the user can listen to.

In a system using a wireless headphone (including a wireless loudspeaker), it must be guaranteed to send music data from the music player main body to the wireless headphone at a constant rate. However, if a wireless communication has suffered disturbance, the wireless communication is readily interrupted especially when an analog signal is sent, and playback sound often becomes discontinuous, thus posing a problem of quality drop.

Also, the music player that plays back compressed music data must has a buffer memory to prevent sound from being disrupted due to a delay of data processes upon playback, and the player main body becomes bulky accordingly.

Jpn. Pat. Appln. KOKAI Publication No. 2001-357618 discloses a technique that can play back music data without interrupting user's listening upon using a portable audio device. However, this technique aims at making a portable audio device take over playback without interrupting listening when the user is listening to music by a floor type audio device, and must go out for some business, but does not aim at suppressing interruption of a wireless communication due to disturbance. This technique does not mention about any problem of an increase in size of the player main body due to the buffer memory.

### BRIEF SUMMARY OF THE INVENTION

Embodiments of the present invention provide a music playback apparatus, headphone, music playback method, which can suppress sound disruption due to, e.g., an interrupted wireless communication while realizing a size reduction of the apparatus main body.

According to one aspect of the present invention, there is provided a headphone comprising a digital data receiver configured to receive music data sent in the form of digital data; a memory configured to save the music data received by the digital data receiver; a digital/analog converter configured to convert music data read out from the memory from digital data into an analog signal; and a sound converter configured to convert the analog signal output from the digital/analog converter into sound.

According to another aspect of the present invention, there is provided a playback apparatus comprising a digital data transmitter configured to transmit music data in the form of digital data; a digital data receiver configured to receive the music data transmitted from the digital data transmitter; a memory configured to save the music data received by the digital data receiver; a digital/analog converter configured to convert music data read out from the memory from digital data into an analog signal; and a sound converter configured to convert the analog signal output from the digital/analog converter into sound.

According to still another aspect of the present invention, there is provided a music playback method of playing back music using a headphone, the method comprising the steps of transmitting music data to the headphone in the form of digital data; and receiving the music data transmitted from the playback apparatus main body, saving the received music data in a buffer memory, reading out the saved music data from the buffer memory, converting the readout data from digital data into an analog signal, and converting the analog signal into sound in the headphone.

Additional embodiments and advantages of the invention will be set forth in the description which follows, and in part will be obvious from the description, or may be learned by practice of the invention. The embodiments and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing the outer appearance of a music player main body and wireless headphone, which form a music playback apparatus according to the first embodiment of the present invention;

FIG. 2 is a block diagram showing the internal arrangements of the music player main body and wireless headphone, which form the music playback apparatus according to the first embodiment;

FIG. 3 is a flow chart for explaining the music playback operation according to the first embodiment;

FIG. 4 is a perspective view showing the outer appearance of a relay device, wireless headphone, and personal computer, which form a music playback apparatus according to the second embodiment of the present invention;

FIG. 5 is a block diagram showing the internal arrangement of the relay device shown in FIG. 4; and

FIG. 6 is a perspective view showing the outer appearance of a wireless card, wireless headphone, and personal computer, which form a music playback apparatus according to the third embodiment of the present invention.

### DETAILED DESCRIPTION OF THE INVENTION

Embodiments of the present invention will be described below with reference to the drawings.

(First Embodiment)

The first embodiment of the present invention will be described below.

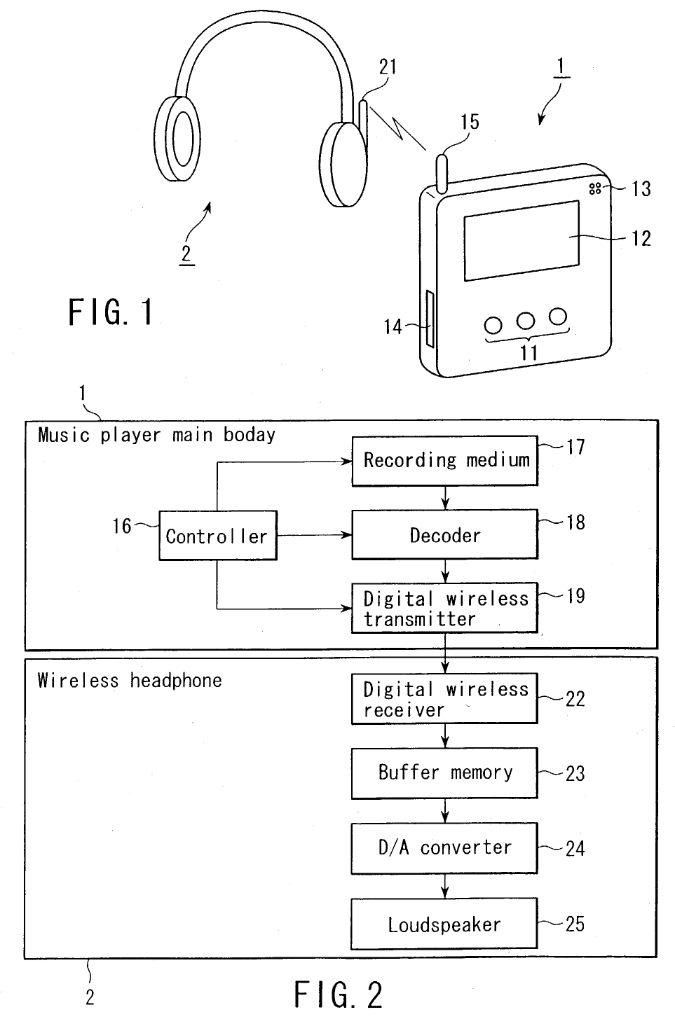

FIG. 1 is a perspective view showing the outer appearance of a music player main body and wireless headphone, which form a music playback apparatus according to the first embodiment of the present invention.

A music player main body 1 is, for example, a portable music player, and can be used while being put in a pocket or bag when it is carried. The music player main body 1 has a console 11, display 12, loudspeaker 13, slot 14, antenna 15, and the like.

The console 11 has control buttons used to play, stop, pause, fastforward, rewind, and so forth music.

The display 12 is used to display information that pertains to a music piece to be played back.

The loudspeaker 13 is used to generate an audible alarm when an inappropriate input operation is made or when a predetermined alarm is generated to the user.

The slot 14 can detachably receive a memory card that stores music data, and loads the stored music data onto an internal recording medium of the player when the memory card is inserted.

The antenna 15 transmits/receives a radio wave upon making wireless communications based on a predetermined standard (e.g., Bluetooth) with another device (a wireless headphone 2 in this case).

On the other hand, a wireless headphone 2 has an antenna 21. This antenna 21 transmits/receives a radio wave upon making wireless communications based on a predetermined standard (e.g., Bluetooth) with another device (the music player main body 1 in this case).

FIG. 2 is a block diagram showing the internal arrangements of the music player main body and wireless headphone, which form the music playback apparatus according to the first embodiment.

The music player main body 1 has a controller 16, recording medium 17, decoder 18, and digital wireless transmitter 19.

The controller 16 controls the overall music player main body 1, and makes control that pertains to a read process of music data from the recording medium 17, a decoding process in the decoder 18, a wireless transmission process in the digital wireless transmitter 19, and the like.

The recording medium 17 is an internal memory of the music player main body 1, and stores music data, associated control information, and the like.

The decoder 18 decodes music data read out from the recording medium 17 (including a process for decompressing compressed data). This read process is intermittently done under the control of the controller 16, and often causes a delay time in the decoding process.

The digital wireless transmitter 19 makes wireless communications based on a predetermined standard (e.g., Bluetooth), and transmits, as digital data, music data output from the decoder 18 to the wireless headphone 2 via a wireless communication. The wireless transmission is made via the aforementioned antenna 15.

On the other hand, the wireless headphone 2 has a digital wireless receiver 22, buffer memory 23, D/A (digital/analog) converter 24, and loudspeakers 25.

The digital wireless receiver 22 makes wireless communications based on a predetermined standard (e.g., Bluetooth), and receives music data transmitted from the digital wireless transmitter 19 of the music player main body 1 via a wireless communication.

The buffer memory 23 temporarily saves (stores) music data received by the digital wireless receiver 22. This buffer memory 23 absorbs not only the delay of music data in the read process from the recording medium 17 and decoding process, but also the influence of any interruption of communications due to disturbance upon wireless transmission. The music data temporarily saved in the buffer memory 23 is sent to the D/A converter 24 at a constant data transfer rate required to play back the data.

The D/A (digital/analog) converter 24 converts music data read out from the buffer memory 23 from digital data into an analog signal.

The loudspeakers 25 convert and output the analog signal output from the D/A converter 24 as sound that the user can listen to.

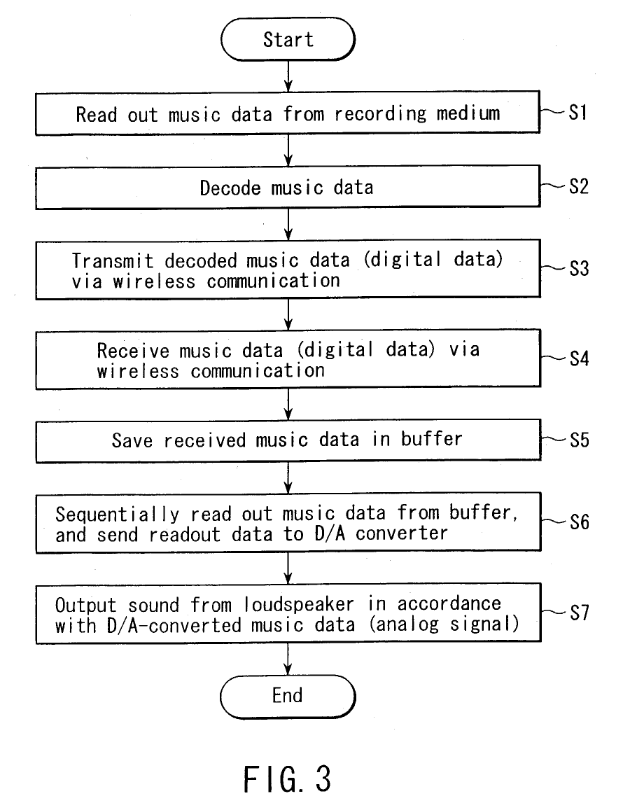

The music playback operation according to this embodiment will be described below with reference to FIG. 3.

On the music player main body 1 side, music data is intermittently read out from the recording medium 17 under the control of the controller 16 (step S1).

The readout music data is decoded by the decoder 18 under the control of the controller 16 (step S2).

The decoded music data is transmitted as digital data from the digital wireless transmitter 19 to the wireless headphone 2 via a wireless communication (step S3).

On the side of the wireless headphone 2, music data as digital data is received by the digital wireless receiver 22 via a wireless communication (step S4).

The music data received by the digital wireless receiver 22 is temporarily saved in the buffer memory 23 (step S5). This buffer memory 23 absorbs any delay of music data in the read process from the recording medium 17 and decoding process, and the influence of any interruption of communications due to disturbance upon wireless transmission.

The music data temporarily saved in the buffer memory 23 is sequentially read out, and is sent to the D/A converter 24 at a data transfer rate suitable for playback (step S6). The D/A converter 24 converts the music data read out from the buffer memory 23 from digital data into an analog signal.

The music data that has been converted into the analog signal is converted and output via the loudspeakers 25 as sound that the user can listen to (step S7).

As described above, according to the first embodiment, since the music player main body 1 need not include a buffer memory and D/A converter, installation areas for them can be reduced, and a further size reduction of the music player main body 1 can be attained.

Since music data is transmitted from the music player main body 1 to the wireless headphone 2 as a digital signal, music data due to disturbance is hardly disrupted compared to wireless transmission using an analog signal, thus preventing sound disruption and quality drop. Since the wireless transmission is made using a digital signal, error correction and re-send of data can be easily attained, and the quality of music to be played back can be further improved.

Since the wireless headphone 2 has the buffer memory 23, not only any delay of music data in the read process from the recording medium 17 and decoding process, but also the influence of any interruption of communications due to disturbance upon wireless transmission can be absorbed.

As for the read process of music data, when the memory card is inserted into the slot 14, music data may be directly read out from the memory card, and may be sent to the decoder 18.

(Second Embodiment)

The second embodiment will be described below.

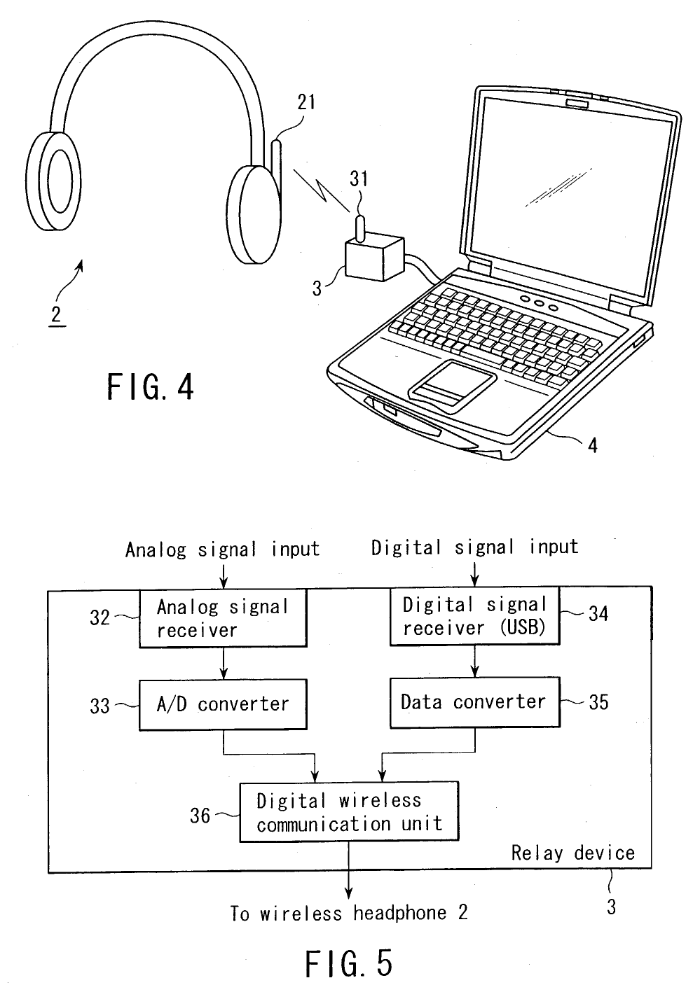

FIG. 4 is a perspective view showing the outer appearance of a relay device, wireless headphone, and personal computer, which form a music playback apparatus according to the second embodiment of the present invention. The wireless headphone 2 is the same as that shown in FIG. 1, and a description thereof will be omitted.

In the second embodiment, functions corresponding to the music player main body 1 described in the first embodiment (FIG. 1) are implemented by a relay device 3 and a personal computer (to be abbreviated as a PC hereinafter) 4.

The PC 4 is a notebook or sub-notebook computer, and can be used while being placed on a desk in the home or while being put in a back when it is carried. The PC 4 has various functions corresponding to the controller 16, recording medium 17, and decoder 18 of the aforementioned music player main body 1, and can externally output generated music data as a digital signal via a USB (Universal Serial Bus) terminal.

On the other hand, the relay device 3 is connected to the PC 4 (or an audio device not shown) via a cable, and has a function of transmitting music data sent from the PC 4 or the like to the wireless headphone 2 via a wireless communication. An antenna 31 equipped on the relay device 3 transmits/receives a radio wave upon making wireless communications based on a predetermined standard (e.g., Bluetooth) with another device (the wireless headphone 2 in this case).

FIG. 5 is a block diagram showing the internal arrangement of the relay device 3 shown in FIG. 4.

The delay device 3 can receive both analog and digital music data, and has an analog signal receiver 32, A/D (analog/digital) converter 34, digital signal receiver 33, data converter 35, and digital wireless communication unit 36.

The analog signal receiver 32 receives decoded music data (e.g., a stereophonic analog audio signal) sent from an audio device when the audio device is connected via a cable, and outputs it to the A/D converter.

The A/D converter 33 converts music data from an analog signal into a digital signal, and outputs the digital signal to the digital wireless communication unit 36.

On the other hand, the digital signal receiver 34 receives decoded music data (e.g., USB compatible digital signal) sent from the PC 4 when the PC 4 is connected via a cable, and outputs it to the data converter 35.

The data converter 35 converts the USB compatible digital signal into a data format that the relay device 3 can internally process, and outputs it to the digital wireless communication unit 36.

The digital wireless communication unit 36 makes wireless communications based on a predetermined standard (e.g., Bluetooth), and transmits input music data as digital data to the wireless headphone 2 via a wireless communication. This wireless transmission is made via the aforementioned antenna 31.

Note that the music playback operation is the same as the flow of the aforementioned flow chart (FIG. 3). In this case, the processes in steps S1 and S2 are executed by the PC 4, and that in step S3 is executed by the relay device 3.

As described above, according to the second embodiment, the music playback apparatus can be constituted by a relay device and wireless headphone, and music can be played back by receiving decoded music data from an external device. In this case as well, the same effects as in the first embodiment can be obtained.

(Third Embodiment)

The third embodiment will be described below.

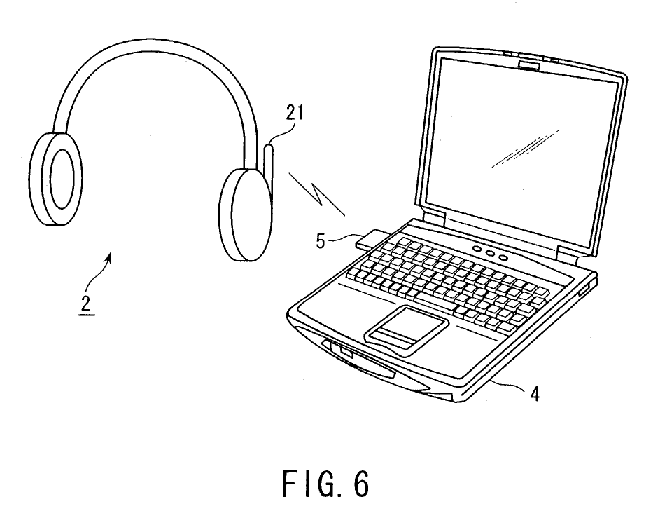

FIG. 6 is a perspective view showing the outer appearance of a wireless card, wireless headphone, and personal computer, which form a music playback apparatus according to the third embodiment of the present invention. Note that the wireless headphone 2 and PC 4 are the same as those shown in FIG. 4, and a description thereof will be omitted.

The third embodiment uses a wireless card 5 in place of the relay device described in the second embodiment (FIG. 4).

The wireless card 5 is a PC card which is externally inserted into a card slot of the PC 4, and makes wireless communications based on a predetermined standard (e.g., Bluetooth). This wireless card 5 receives music data generated by the PC 4 as digital data, and transmits that music data to the wireless headphone 2 as digital data via a wireless communication. This wireless transmission is made via an antenna equipped on the wireless card 5.

Note that the music playback operation is the same as the flow of the aforementioned flow chart (FIG. 3). In this case, the processes in steps S1 and S2 are executed by the PC 4, and that in step S3 is executed by the wireless card 5.

As described above, according to the third embodiment, the music playback apparatus can be constituted by the wireless card and wireless headphone, and music can be played back by receiving decoded music data from the PC or the like. In this case as well, the same effects as in the first and second embodiments can be obtained.

As described in detail above, according to the present invention, sound disruption due to interruption of wireless communications can be suppressed while realizing a size reduction of the apparatus main body.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A headphone comprising:
a digital data receiver configured to receive music data sent in the form of digital data;
a memory configured to save the music data received by the digital data receiver;
a digital/analog converter configured to convert music data read out from the memory from digital data into an analog signal; and
a sound converter configured to convert the analog signal output from the digital/analog converter into sound.

2. The headphone according to claim 1, in which the memory includes a buffer memory.

3. The headphone according to claim 1, in which the music data saved in the memory is sent to the digital/analog converter at a constant data transfer rate.

4. A playback apparatus comprising:
a digital data transmitter configured to transmit music data in the form of digital data;
a digital data receiver configured to receive the music data transmitted from the digital data transmitter;
a memory configured to save the music data received by the digital data receiver;
a digital/analog converter configured to convert music data read out from the memory from digital data into an analog signal; and
a sound converter configured to convert the analog signal output from the digital/analog converter into sound.

5. The apparatus according to claim 4, further comprising a decoder configured to decode music data read out from a recording medium, wherein the digital data transmitter transmits music data output from the decoder.

6. The apparatus according to claim 5, in which the decoder and the digital data transmitter are provided to a playback apparatus main body, and the digital data receiver, the memory, the digital/analog converter, and the sound converter are provided to a headphone.

7. The apparatus according to claim 5, in which the memory includes a buffer memory.

8. The apparatus according to claim 5, in which the music data saved in the memory is sent to the digital/analog converter at a constant data transfer rate.

9. The apparatus according to claim 4, in which the digital data transmitter receives decoded music data from outside, and transmits the received music data.

10. The apparatus according to claim 9, in which the digital data transmitter is provided to a relay device, and
the digital data receiver, the memory, the digital/analog converter, and the sound converter are provided to a headphone.

11. The apparatus according to claim 9, in which the memory includes a buffer memory.

12. The apparatus according to claim 9, in which the music data saved in the memory is sent to the digital/analog converter at a constant data transfer rate.

13. A music playback method of playing back music using a headphone, the method comprising the steps of:
transmitting music data to the headphone in the form of digital data; and
receiving the music data transmitted from the playback apparatus main body, saving the received music data in a buffer memory, reading out the saved music data from the buffer memory, converting the readout data from digital data into an analog signal, and converting the analog signal into sound in the headphone.

14. The method according to claim 13, further comprising reading out and decoding music data from a recording medium in a playback apparatus before transmission of the music data to the headphone.

15. The method according to claim 13, further comprising receiving decoded music data by a relay device from outside before transmission of the music data to the headphone.

16. The method according to claim 13, further comprising causing the music data saved in the buffer memory to be sent to a digital/analog converter at a constant data transfer rate.
